(19) United States
(12) Patent Application Publication
(10) Pub. No.: US 2025/0259078 A1
(43) Pub. Date: Aug. 14, 2025

(54) SYSTEMS AND METHODS FOR EXTRACTING HYPOTHETICAL STATEMENTS FROM UNSTRUCTURED DATA

(71) Applicant: SocialTrendly, Inc. d/b/a/ Blackbird.AI, Rochester, NY (US)

(72) Inventors: Vanya Cohen, Rochester, NY (US); Abul Hasnat, Noisy le Grand (FR); Paul Burkard, Kure Beach, NY (US); Naushad UzZaman, Bellmore, NY (US)

(73) Assignee: SocialTrendly, Inc. d/b/a Blackbird.AI, Rochester, NY (US)

(21) Appl. No.: 18/781,866

(22) Filed: Jul. 23, 2024

Related U.S. Application Data
(60) Provisional application No. 63/553,040, filed on Feb. 13, 2024.

(51) Int. Cl. G06N 5/022

(52) U.S. Cl. CPC G06N 5/022

(57) ABSTRACT

Disclosed embodiments may provide techniques for extracting hypothetical statements from unstructured data. A computer-implemented method can include accessing input data that includes unstructured data. The computer-implemented method can also include processing the input data using a statement-extraction machine-learning model to generate a plurality of candidate hypothetical statements and summary data associated with the input data. The computer-implemented method can also include constructing one or more filtering prompts for filtering the plurality of candidate hypothetical statements. The computer-implemented method can also include processing the one or more filtering prompts and the plurality of candidate hypothetical statements using the statement-extraction machine-learning model to identify one or more hypothetical statements. In some instances, the one or more hypothetical statements correspond to one or more non-factual assertions associated with the unstructured data. The computer-implemented method can also include transmitting the summary data of the input data and the one or more hypothetical statements.

### CROSS-REFERENCES TO RELATED APPLICATIONS

The present application claims priority from and is a non-provisional of U.S. Provisional Application No. 63/553,040, entitled “AUTOMATED CONTEXTUAL ANALYSIS AND FACT-VERIFICATION SYSTEM FOR MULTIMODAL CONTENT” filed Feb. 13, 2024, the contents of which are herein incorporated by reference in its entirety for all purposes.

### FIELD

The present disclosure relates generally to generating contextual data associated with unstructured data. In one example, the systems and methods described herein may be used to extract hypothetical statements from the unstructured data, in which the contextual data can be determined based on the hypothetical statements.

### SUMMARY

Disclosed embodiments may provide techniques for extracting hypothetical statements from unstructured data. A computer-implemented method can include accessing input data that includes unstructured data. In some instances, the unstructured data includes image data, video data, and/or an audio data, three-dimensional data, hypertext data, computer-readable code, geo-location data, time data, medical data, and/or sensor data. The computer-implemented method can also include processing the input data using a statement-extraction machine-learning model to generate a plurality of candidate hypothetical statements and summary data associated with the input data. The computer-implemented method can also include constructing one or more filtering prompts for filtering the plurality of candidate hypothetical statements.

The computer-implemented method can also include processing the one or more filtering prompts and the plurality of candidate hypothetical statements using the statement-extraction machine-learning model to identify one or more hypothetical statements. In some instances, the one or more hypothetical statements correspond to one or more non-factual assertions associated with the unstructured data. In some instances, the statement-extraction machine-learning model is fine-tuned using in-context learning with few-shots technique.

If the unstructured data includes image data, the statement-extraction machine-learning model can be applied to the image data to generate an image-based candidate hypothetical statement. The image-based candidate hypothetical statement can include a description of one or more image objects depicted in the image data. Additionally or alternatively, the image-based candidate hypothetical statement can also include a classification of whether the image data includes machine-generated images.

If the unstructured data includes video data, the statement-extraction machine-learning model can be applied to the video data to generate a video-based candidate hypothetical statement. The video-based candidate hypothetical statement can include a description of one or more video objects streamed on the video data.

If the unstructured data includes audio data, the statement-extraction machine-learning model can be applied to the audio data to generate an audio-based candidate hypothetical statement. The audio-based candidate hypothetical statement can include a description of one or more objects specified in the audio data.

The computer-implemented method can also include transmitting the summary data of the input data and the one or more hypothetical statements. The summary data of the input data and the one or more hypothetical statements can be processed using a context-determination machine-learning model to generate contextual data associated with the input data. The contextual data can be used to determine whether the unstructured data includes unverified or misleading information. In some instances, the statement-extraction machine-learning model and the context-determination machine-learning model correspond to the same machine-learning model. Alternatively, the statement-extraction machine-learning model is different from the context-determination machine-learning model.

In some instances, background data is accessed from one or more external databases, in which the contextual data is generated further based on the background data. In some instances the background data includes additional information that describes at least part of the unstructured data.

In an embodiment, a system comprises one or more processors and memory including instructions that, as a result of being executed by the one or more processors, cause the system to perform the processes described herein. In another embodiment, a non-transitory computer-readable storage medium stores thereon executable instructions that, as a result of being executed by one or more processors of a computer system, cause the computer system to perform the processes described herein.

Various embodiments of the disclosure are discussed in detail below. While specific implementations are discussed, it should be understood that this is done for illustration purposes only. A person skilled in the relevant art will recognize that other components and configurations can be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which can be exhibited by some embodiments and not by others.

The terms used in this specification generally have their ordinary meanings in the art, within the context of the disclosure, and in the specific context where each term is used. Alternative language and synonyms can be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles can be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

Illustrative embodiments are described in detail below with reference to the following

figures.

FIG. 1 shows an example schematic diagram for automated contextual analysis and fact-verification of multimodal content, according to some embodiments.

FIG. 2 illustrates an example computing environment for automated contextual analysis and fact-verification of multimodal content, according to some embodiments.

FIG. 3 shows an illustrative example of a process for automated contextual analysis and fact-verification of multimodal content, in accordance with some embodiments.

FIG. 4 illustrates an example schematic diagram for extracting hypothetical statements from unstructured data, according to some embodiments.

FIG. 5 illustrates an example computing environment for extracting hypothetical statements from unstructured data, according to some embodiments.

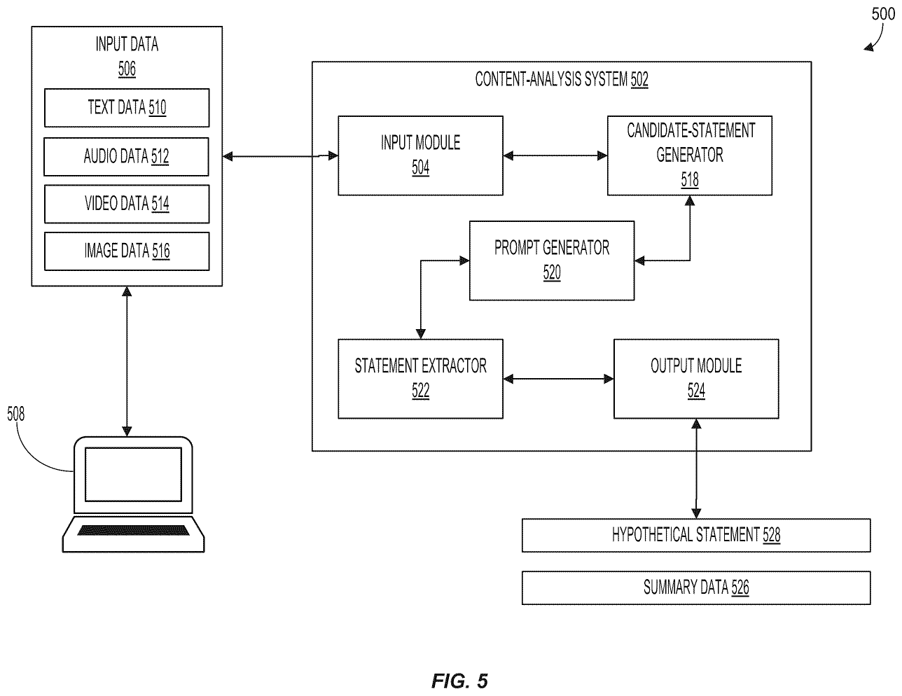

FIG. 6 shows an illustrative example of a process for extracting hypothetical statements from unstructured data, in accordance with some embodiments.

FIG. 7 shows a computing system architecture including various components in electrical communication with each other using a connection in accordance with various embodiments.

In the appended figures, similar components and/or features can have the same reference label. Further, various components of the same type can be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

In the following description, for the purposes of explanation, specific details are set forth in order to provide a thorough understanding of certain inventive embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

Misinformation on the internet has become a pervasive and concerning issue, presenting a complex challenge that spans various domains. As used herein, misinformation refers to false or misleading information disseminated through online or offline platforms, often with the intent to deceive or manipulate audiences. This misinformation can take many forms, including fake news articles, fabricated images or videos, misleading social media posts, and deceptive websites. The misinformation can spread rapidly across digital networks, amplified by the viral nature of social media and the case of sharing information online. The consequences of misinformation are far-reaching, ranging from undermining trust in credible sources of information to fueling societal divisions, influencing public opinion, and even inciting real-world harm.

To address the problem of misinformation, technical solutions such as fact-checking algorithms, content moderation tools, and digital verification techniques have been implemented. For example, two existing techniques can include the following: (i) machine-learning classification techniques; and (ii) claim-matching techniques. With respect to machine-learning classification techniques, machine-learning models can be trained using datasets that include true and false statements, such that the machine-learning models can classify whether a given input statement is true or false. In comparison, claim-matching techniques can involve comparing incoming text to a database of claims to find one or more similar claims to verify the incoming text. Both existing techniques have drawbacks, however. For example, both existing techniques rely on static datasets and require manual updates of databases and retraining of models, which are impractical for several situations that involve real-time information.

Moreover, existing techniques associated with claim matching extensively rely on updating claim databases in real time (e.g., fact-checking websites). Updating the claim databases, however, often require human fact-checkers to establish the veracity of claims and write articles debunking them, which can become challenging as the amount of data continues to grow exponentially. Such challenges can highlight the limitations of relying on such databases for immediate verification of different hypothetical statements. Accordingly, existing techniques can be inadequate for achieving real-time assessment of claims (also referred herein as “hypothetical statements”) associated with a particular input data (e.g., video, image, news article, social media post). Accordingly, there is a need for addressing time-sensitive nature of misinformation online, including a need for rapid-assessment techniques of real-time data.

To overcome the above-noted deficiencies, disclosed embodiments may provide techniques for extracting hypothetical statements from unstructured data. A content-analysis system can access input data. In some instances, the input data includes unstructured data. The unstructured data can include image data, video data, audio data, three-dimensional data, hypertext data, computer-readable code, geo-location data, time data, medical data, sensor data, or any combinations thereof. In some instances, the unstructured data includes multi-modal inputs such as video data and text data. The multi-modal inputs can involve the integration of various types of data, such as the text data, the image data, the audio data, and the video data, such that the inputs can be processed by one or more machine learning systems.

The content-analysis system can process the input data using a statement-extraction machine-learning model to generate a plurality of candidate hypothetical statements and summary data associated with the input data. For example, if the unstructured data includes image data, the candidate-statement generator can apply the statement-extraction machine-learning model to the image data to generate an image-based candidate hypothetical statement. The image-based candidate hypothetical statement can include a description of one or more image objects depicted in the image data. In some instances, the description includes identifying a person or an entity associated with the one or more image objects (e.g., logos indicating a particular entity). Additionally or alternatively, the image-based candidate hypothetical statement can be generated to include a classification of whether the image data includes machine-generated images. The detection of machine-generated images can be used to determine whether a particular hypothetical statement is substantiated or unsubstantiated with evidence.

In some instances, the statement-extraction machine-learning model can process multi-modal input data (e.g., video and text, image and text). As an example implementation, the statement-extraction machine-learning model can be configured as a single vision-language model that is trained and fine-tuned to directly process multiple modalities to generate the plurality of candidate hypothetical statements and the summary data. In another example implementation, the statement-extraction machine-learning model can be configured as multiple machine-learning models, in which each machine-learning model is trained and fine-tuned to process a corresponding type of modality.

The content-analysis system can construct one or more filtering prompts for filtering the plurality of candidate hypothetical statements. In some instances, a filtering prompt includes a sequence of text tokens in a specific format (e.g., text, XML data, JSON data) and language (e.g., English, Korean). The content-analysis system can process the one or more filtering prompts and the plurality of candidate hypothetical statements using the statement-extraction machine-learning model to identify one or more hypothetical statements. In some instances, the one or more hypothetical statements correspond to one or more non-factual assertions associated with the unstructured data.

The content-analysis system can transmit the summary data of the input data and the one or more hypothetical statements. In some instances, the summary data of the input data and the one or more hypothetical statements are processed using a context-determination machine-learning model to generate contextual data associated with the input data. The contextual data can be processed to determine whether the unstructured data includes unverified or misleading information. By leveraging the use of statement-extraction machine-learning model, the present techniques can rapidly assess input data and generate the contextual data that can be consistent with real-time verification data.

The present techniques thus automatically provide context and verify the accuracy of input content from various modalities. The modalities can include but are not limited to text, images, video, and hypertext. The system can include a digital agent that iteratively executes information retrieval requests while evaluating domain reliability and source trustworthiness. The system can generate a context summary by analyzing input content against gathered information, complete with source citations, and optionally assigns a verdict label to indicate the truthfulness of the analyzed claims. To combat online misinformation and disinformation, the present techniques are scalable to large volumes of content and can handle a wide array of input types and sources without the need for predefined information ontologies. The present techniques allow users to discern the reliability of information encountered online through this additional context, thereby overcoming the challenges posed by the rapid spread of misinformation and the evolving digital landscape.

In contrast to the conventional techniques, embodiments of the present disclosure can include deploying an agent for the task of context and fact-checking and is in principle limited only by the intelligence of the underlying ML models. We assume as little structure as possible about the problem and content and instead develop a system which can utilize arbitrary and constantly updated information sources, and analyze content in a wide range of mediums. Embodiments of the present disclosure are agnostic with respect to claim granularity, information sources, and procedures for analysis. Instead we choose a generalist agent framework which utilizes learning from examples in place of manually specified pipelines for claim analysis.

Autonomous agents based on pretrained multimodal models can be advantageous over conventional techniques. For example, some conventional techniques largely perform simple input-output tasks, and do not take actions or selectively access information of their own volition. Other conventional techniques include using web-search augmented language models. These do form rudimentary agents, but their ability to interface with multimodal content is limited and they are not designed for fact-checking. By contrast, the present techniques address the two main limitations of previous approaches: (1) the requirement to constantly update a fixed ontology of misinformation claims; and (2) the ability to handle a large volume of input content accurately without human intervention.

The present techniques can be deployed for many different use-cases, including: (1) direct 3rd party consumption via an API for content moderation (removing or augmenting content on a platform); (2) the automatic detection and analysis of misinformation and disinformation campaigns; (3) analysis of websites and other venues for brand safety for digital advertising; and (4) individual use in a consumer application to provide context for end-user digital information consumption. The present techniques can be used in an information consumption platform that provides summarized information while protecting a user from raw harmful misinformation.

### I. Techniques For Automated Contextual Analysis and Fact-Verification of Multimodal Content

Online misinformation and disinformation have created serious disruptions to commerce and political systems, and have caused personal injury. Users of social media and other internet sites need a way to assess the veracity of digital media to prevent these harms. The present techniques can address this problem by producing a qualitative analysis which analyzes the claims made in the context of reliable sources that address the claims. The present techniques can also provide a verdict label which indicates the degree to which the input claims should be trusted. Both of these outputs serve to inform the user about the quality of the information input and to guide the user towards reliable sources of information on controversial topics.

At the same time, freedom of expression dictates that a wide variety of speech is permissible in public spaces. Legally and by the terms of service of many online platforms, users can and should be allowed to post claims which may turn out to be false, or are only partially or subjectively true. Further, with generative AI it is easy for individual actors to cheaply produce large volumes of such harmful content. Such proliferation of false claims leads to two attributes of the problem: a large quantity and high novelty of misinformation. Digital platforms have previously relied heavily on human review to address these novel threats, as humans can more easily learn about and adapt to new misinformation than machine systems. But these conventional techniques do not scale easily, and some content is missed in review, or does not meet standards for removal while still being harmful. At the same time, automated systems do scale, but have thus far relied on curating a fixed set of known harmful misinformation.

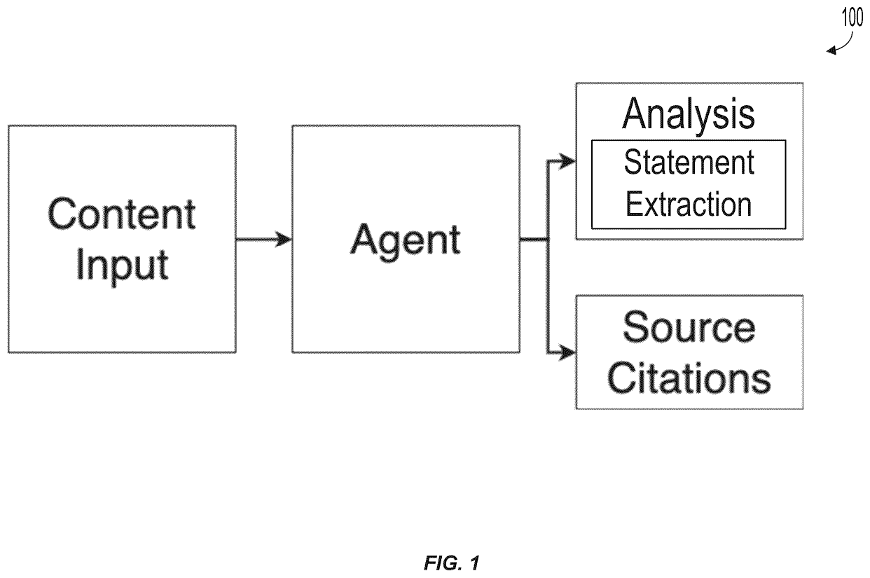

The present techniques address the problem of analyzing large amounts of content at scale while not relying on a fixed ontology of disinformation. By automatically searching the web and other sources for relevant and trustworthy background information the system is able to handle novel threats at scale. FIG. 1 shows an example schematic diagram 100 for automated contextual analysis and fact-verification of multimodal content, according to some embodiments. As shown in FIG. 1, the contextual analysis and fact-verification of multimodal content can include extracting hypothetical statements from unstructured data using machine-learning techniques. The extraction of hypothetical statements is further described in Section II of the present disclosure.

In sum, online misinformation and disinformation create numerous harms, from reputational harms, to financial harms such as stock price manipulation, to personal injuries as in the case of fraudulent medical advice. Automatically directing users to trusted information around the content they are consuming can serve to minimize these harms.

### A. Computing Environment

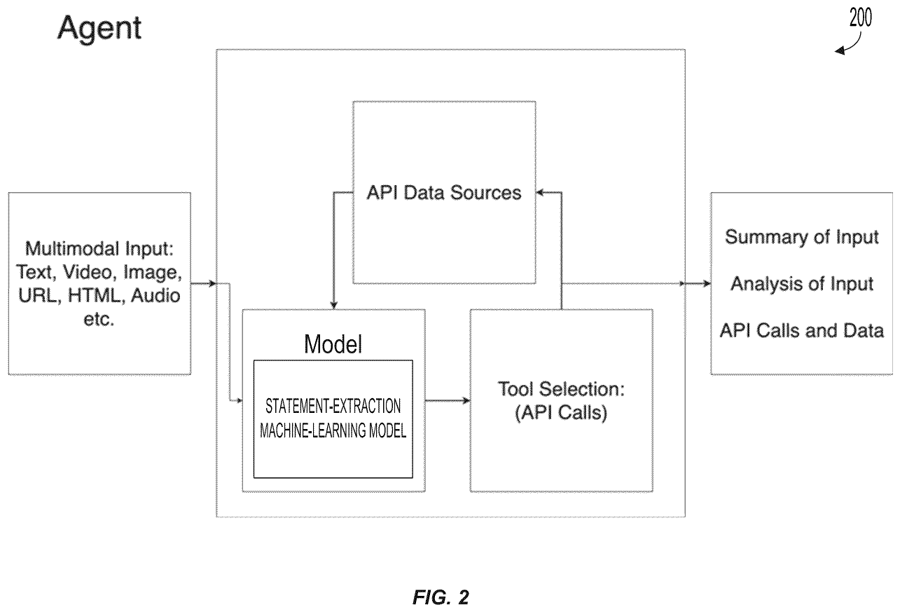

FIG. 2 illustrates an example computing environment 200 for automated contextual analysis and fact-verification of multimodal content, according to some embodiments. The present techniques can combine three modules, the “Model”, “Tool selection”, and “API Data Sources” into a decision making loop. At each step of the cycle, the Model receives some (multimodal content) input and selects a “Tool” to use. These Tools make use of API Data Sources to gather additional multimodal content, and feed these as input to the model.

This loop operates until a fixed number of cycles is reached, or the model emits a “Done” Tool Selection, indicating that the agent believes it's time to stop the process. The output is a summary of the claims made in the original input, sources used to evaluate those claims, and an analysis of the claims in the context of the sources. Here the External Sources Used is a summary or abstraction of the API Data Sources accessed during the process.

The core abstraction revolves around the AI definition of a decision-making agent. This agent receives observations from the “environment” e.g. Multimodal Input and API Data Sources. It maps these observations to actions (Tool Selections). These actions interact with the environment to produce new observations (API Data Source Outputs).

Model: This is a large multimodal language model capable of receiving text, image, video, and audio as input. In some instances, the model includes a statement-extraction model that is trained to extract hypothetical statements from unstructured data (e.g., multimodal data). As described herein, the extraction of hypothetical statements is further described in Section II of the present disclosure.

Tool Selection: This component queries the Model to produce tool invocations, these take the form of function calls with arguments.

API Data Sources: The Tool Selection module outputs tool invocations which are implemented using a mechanism for accessing external APIs such as search engines, domain trustworthiness databases, etc. These API calls return data which is passed back to the Model as additional context for the next iteration.

Additionally or alternatively, instead of relying upon a predefined set of APIs to contextualize online content, multimodal pretrained models can be used to operate graphical user interfaces, command line interfaces, and computer terminal interfaces. Any or all of these environments could thus replace the “Tool Selection” and “API Data Source” components. Instead of the model controlling an agent which outputs predefined API calls, it could simply operate a graphical web browser directly or control any computer system through writing code. This would allow for limitless extensibility in the data sources it could access. The system could utilize web information not readily available through an API, or perform logical deductions of claim truth values by reducing such claims to computer code. In the most imaginative cases, it could even contact through email or phone human experts, local libraries, and public records agencies to retrieve non-digitized information.

The system is applicable to the real-time contextualization of all media including video, audio, live conversations, and news content. Future use-cases could serve to interpret and contextualize potentially harmful information in a variety of settings including as a intermediate layer between a user and their computer applications (web browsing, instant messaging, video calls) and real-life contexts (as an interactive application running on an augmented reality headset), to protect users from unfiltered falsehoods and help users make well informed decisions about their daily media consumption and resulting world-view. This “context layer” of digital and real-world interface would form a potent obstacle to those who wish to promulgate falsehoods to deceive or manipulate.

### B. Methods

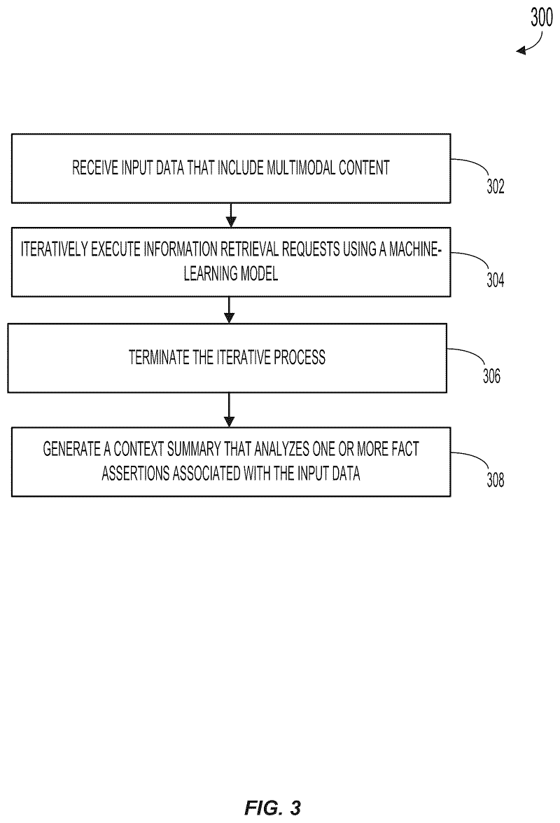

FIG. 3 shows an illustrative example of a process 300 for automated contextual analysis and fact-verification of multimodal content, in accordance with some embodiments. For illustrative purposes, the process 300 is described with reference to the components illustrated in FIG. 2, though other implementations are possible.

At step 302, a content-analysis system can receive input data. The input data can include user-provided content (including URLs or multimodal content). The content can be associated with one or more assertions.

At step 304, the content-analysis system can iteratively execute information retrieval requests and identifies domain-reliability and trustworthiness information. At each step of the process, a digital agent of the content-analysis system can execute one or more information retrieval requests, which can be generated by applying a machine-learning model (e.g., an LLM model) to the input data.

At step 306, the agent can terminate the iterative process at any time, or after a fixed number of iterations.

At step 308, the agent can generate a context summary which analyzes the original input content in the context of the information found, complete with source citations. In effect, the context summary can indicate veracity of the fact assertions associated with the input data. The content-analysis system can optionally produce a “verdict” label indicating the truthfulness of the original claims. Process 300 terminates thereafter.

### II. Techniques For Extracting Hypothetical Statements From Unstructured Data

### A. Example Implementation

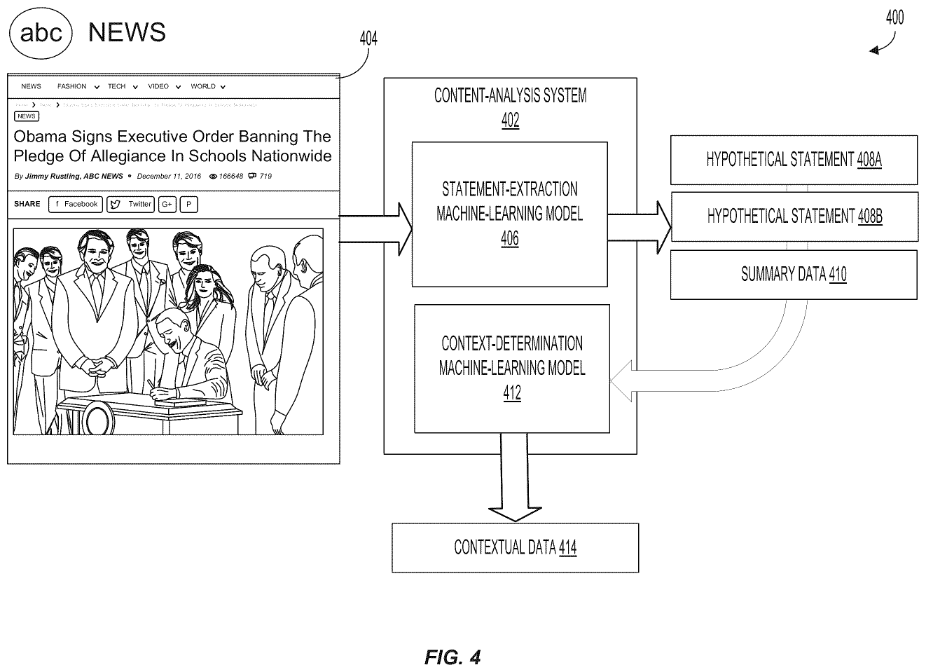

FIG. 4 illustrates an example schematic diagram 400 for extracting hypothetical statements from unstructured data, according to some embodiments. In FIG. 1, a content-analysis system 402 accesses input data 404. In some instances, the input data 404 includes unstructured data. The unstructured data can include image data, video data, audio data, three-dimensional data, hypertext data, computer-readable code, geo-location data, time data, medical data, sensor data, or any combinations thereof. As an illustrative example, the input data 404 can include an image depicting the president, the vice president, and members of his cabinet, in which the image further depicts the president signing a document. The input data 404 further includes a title of an article stating “Obama Signs Executive Order Banning The Pledge Of Allegiance In Schools Nationwide.” The input data 404 further includes another image that depicts a fake logo of a particular news outlet (e.g., “abc News”). As evident in the image and the accompanying text, the input data 404 appears to provide an unsubstantiated and misleading statement with the intent to deceive or manipulate audiences.

The content-analysis system 402 can process the input data 404 using a statement-extraction machine-learning model 406 to generate one or more hypothetical statements 408A-B and summary data 410 associated with the input data 404. As used herein, the term “hypothetical statement” can refer to a statement or assertion of fact that excludes sufficient substantiation, evidence, or proof. The summary data 410 can correspond to a distilled version of the input data 404 (e.g., a shorter text form) such that, the summary data 410 describes one or more aspects associated with the input data 404. Continuing with the example in FIG. 1, the content-analysis system 402 can process the input data 404 to identify a first hypothetical statement 408A (“The image depicts the president signing a document”) and a second hypothetical statement 408B (“The president signed an executive order banning the pledge of allegiance in schools”). Other hypothetical statements in this example can include “The president is unpatriotic”, “The president supports limiting freedom of expression”, “The article was published by abc news”, etc. Additionally or alternatively, the summary data 410 can further indicate the sentiment of the input data 404 (e.g., positive sentiment depicted in the image).

In some instances, the content-analysis system 402 initially identifies a plurality of candidate hypothetical statements (not shown). In some instances, the plurality of candidate hypothetical statements correspond to hypothetical statements that describe various aspects relating to the input data 404. The content-analysis system 402 can then select the one or more hypothetical statements 408A-B from the candidate hypothetical statements by processing the candidate hypothetical statements and one or more filtering prompts using the statement-extraction machine-learning model 406.

The content-analysis system 402 can then process the summary data 410 and the one or more hypothetical statements 408 using a context-determination machine-learning model 412 to generate contextual data 414 associated with the input data 404. In some instances, the contextual data 414 can indicate whether the input data 404 includes unverified or misleading information. Continuing with the example, the contextual data 414 can indicate that the image and text of the input data 404 can indicate misleading information associated with the president banning pledge of allegiance in schools nationwide. The contextual data 414 can further indicate that the image object “abc news” is an inaccurate image of a news outlet, in which the image object is being used mislead the audience that the news article originated from a reputable source.

In some instances, the content-analysis system 402 includes a retrieval-augmentation system that can access background data from one or more external databases (e.g., knowledgebase), in which the background data includes additional information associated with the unstructured data. The content-analysis system 402 can then generate the contextual data 414 further based on the background data. In some instances, the statement-extraction machine-learning model 406 and the context-determination machine-learning model 412 correspond to the same machine-learning model (e.g., a transformer model). Additionally or alternatively, the statement-extraction machine-learning model 406 is different from the context-determination machine-learning model 412.

### B. Computing Environment

FIG. 2 illustrates an example computing environment 200 for extracting hypothetical statements from unstructured data, according to some embodiments.

### 1. Input Module

To initiate the process for extracting hypothetical statements from unstructured data, an input module 504 of a content-analysis system 502 can access input data 506. The content-analysis system 502 can be a computer system that can take any suitable physical form. As example and not by way of limitation, the content-analysis system 502 can be an embedded computer system, a system-on-chip (SOC), a single-board computer system (SBC) (such as, for example, a computer-on-module (COM) or system-on-module (SOM)), a desktop computer system, a mainframe, a mesh of computer systems, a server, or a combination of two or more of these. Where appropriate, the computer system may include one or more computer systems; be unitary or distributed; span multiple locations; span multiple machines; and/or reside in a cloud computing system which may include one or more cloud components in one or more networks as described herein in association with the computing resources provider (e.g., the computing resources provider 728).

In some instances, the input module 504 accesses the input data 506 by receiving the input data 506 transmitted by a user device 508. The user device 508 can be a client device that includes a desktop computer system, a laptop or notebook computer system, a tablet computer system, a wearable computer system or interface, an interactive kiosk, a mainframe, a mesh of computer systems, a mobile telephone, a personal digital assistant (PDA), or a combination of two or more of these.

The input data 506 can include information corresponding to one or more modalities that are processed to generate a target output (e.g., hypothetical statements). For example, the input data 506 can correspond to an image that can be processed by the content-analysis system 502 to generate the hypothetical statements. In some instances, the input data 506 corresponds to a hyperlink of one or more websites or applications, in which the content-analysis system 502 can access and process the content associated with the one or more websites or applications to generate the hypothetical statements.

The input data 506 can be transmitted across a communication network. The network can be any network including an internet, an intranet, an extranet, a cellular network, a Wi-Fi network, a local area network (LAN), a wide area network (WAN), a satellite network, a Bluetooth® network, a virtual private network (VPN), a public switched telephone network, an infrared (IR) network, an internet of things (IoT network) or any other such network or combination of networks. Communications by the client device via the network can be wired connections, wireless connections, or combinations thereof. Communications via the network can be made via a variety of communications protocols including, but not limited to, Transmission Control Protocol/Internet Protocol (TCP/IP), User Datagram Protocol (UDP), protocols in various layers of the Open System Interconnection (OSI) model, File Transfer Protocol (FTP), Universal Plug and Play (UPnP), Network File System (NFS), Server Message Block (SMB), Common Internet File System (CIFS), and other such communications protocols.

In some instances, the input data 506 includes unstructured data, such as text data 510, audio data 512, video data 514, and image data 516. As used herein, the term “unstructured data” can refer to any data that does not conform to a predefined schema or data model (e.g., relational databases characterized by rows and columns). The unstructured data can be associated with plurality of formats such as text documents, emails, social media posts, images, videos, audio recordings, and web content. In some instances, the unstructured data can be processed using natural language processing (NLP) for analyzing text data 510, machine learning algorithms for pattern recognition within the audio data 512, and computer vision for interpreting image data 516 and/or the video data 514. Storage and management of the unstructured data can include implementing NoSQL databases, distributed file systems (e.g., Hadoop), and/or cloud-based infrastructures that can accommodate large volumes and diverse data types.

In some instances, the unstructured data can include multi-modal inputs such as video data 514 and text data 510. In effect, the hypothetical statements can be extracted based on processing both the video data 514 and the text data 510. The multi-modal inputs can involve the integration of various types of data, such as the text data 510, the image data 516, the audio data 512, and the video data 514, such that the inputs can be processed by one or more machine learning systems. The multi-modal approach allows the ensuing machine-learning models to process and analyze information from diverse sources simultaneously, thus providing better context associated with the unstructured data.

By transforming or encoding multiple modalities into input features, the machine-learning models can capture complex relationships and nuances that may be missed when considering each modality in isolation. For example, in a human-computer interaction scenario, multi-modal inputs enable the machine-learning systems to interpret both spoken commands and accompanying gestures.

### 2. Candidate-Statement Generator

A candidate-statement generator 518 of the content-analysis system 502 can process the input data 506 using a statement-extraction machine-learning model to generate a plurality of candidate hypothetical statements and summary data associated with the input data. In some instances, the hypothetical statement includes one or more declarations of belief, opinion, or fact that are yet to be verified. For example, a given hypothetical statement can include a statement that a person “can run a mile in under six minutes,” but without the person providing immediate evidence. Hypothetical statements can be associated with various topics, including factual events, abilities, rights, or opinions, although they often require further validation or evidence to be substantiated. For example, the one or more hypothetical statements can correspond to one or more non-factual assertions associated with the unstructured data.

In some instances, the plurality of candidate hypothetical statements correspond to hypothetical statements that describe various aspects relating to the unstructured data. The content-analysis system 502 can later select one or more statements from the candidate hypothetical statements to determine the hypothetical statements that represent the input data.

The summary data can correspond to a distilled version of the input data 506 (e.g., a shorter text form) that describes one or more aspects associated with the input data 506. In some instances, the candidate-statement generator 518 can use the statement-extraction machine-learning model to generate the summary data based on an extractive summarization technique, in which the statement-extraction machine-learning model identifies statements directly from the unstructured data and compiles the statements to form the summary data. Additionally or alternatively, the candidate-statement generator 518 can use the statement-extraction machine-learning model to generate the summary data based on an abstractive summarization technique, in which the statement-extraction machine-learning model synthesizes new statements that capture the one or more aspects associated with the input data 506. In some instances, the summary data is processed in subsequent implementation steps not only to determine content of the contextual data, but also to identify various characteristics associated with the input data. For example, if the input data corresponds to a web document advocating the use of vaccines, the summary data can be generated to reflect an overall negative sentiment against anti-vaccine theories and provide information about vaccine safety.

The statement-extraction machine-learning model can be implemented to process various types of input data to generate the plurality of candidate hypothetical statements and the summary data. In some instances, if the unstructured data includes image data 516, the candidate-statement generator 518 can apply the statement-extraction machine-learning model to the image data 516 to generate an image-based candidate hypothetical statement. The image-based candidate hypothetical statement can include a description of one or more image objects depicted in the image data 516. In some instances, the description includes identifying a person or an entity associated with the one or more image objects (e.g., logos indicating a particular entity). Additionally or alternatively, the image-based candidate hypothetical statement can be generated to include a classification of whether the image data 516 includes machine-generated images. The detection of machine-generated images can be used to determine whether a particular hypothetical statement is substantiated or unsubstantiated with evidence.

In some instances, if the unstructured data includes video data 514, the candidate-statement generator 518 can apply the statement-extraction machine-learning model to the video data 514 to generate a video-based candidate hypothetical statement. The video-based candidate hypothetical statement can include a description of one or more video objects streamed on the video data 514. Additionally or alternatively, the video-based candidate hypothetical statement can be generated to also include a classification of whether the video data includes machine-generated videos.

In some instances, if the unstructured data includes audio data 512, the candidate-statement generator 518 applies the statement-extraction machine-learning model to the audio data 512 to generate an audio-based candidate hypothetical statement. The audio-based candidate hypothetical statement can include a description of one or more objects specified in the audio data 512. Similar to image-based and video-based hypothetical statements, the audio-based candidate hypothetical statement can also include a classification of whether the audio data 512 includes machine-generated audio.

In some instances, the statement-extraction machine-learning model can process multi-modal input data (e.g., video and text, image and text). As an example implementation, the statement-extraction machine-learning model can be configured as a single vision-language model that is trained and fine-tuned to directly process multiple modalities to generate the plurality of candidate hypothetical statements and the summary data. In another example implementation, the statement-extraction machine-learning model can be configured as multiple machine-learning models, in which each machine-learning model is trained and fine-tuned to process a corresponding type of modality.

The statement-extraction machine-learning model can correspond to a machine-learning model that is trained to process the unstructured data and generate the hypothetical statements and the summary data. In some instances, the statement-extraction machine-learning model is a generative model configured to generate content (e.g., text responses) based on input (e.g., prompts). For example, the statement-extraction machine-learning model can generate a particular text token based on an input prompt, predict the next text token that follows the particular text token, and iterating the process of predicting the subsequent text tokens to generate a coherent sequence of text tokens that represent the content. In effect, given an initial input, the statement-extraction machine-learning model can use its learned patterns from the training data to produce each following text token in the sequence, thereby creating a complete text output that is contextually relevant and fluent. The statement-extraction machine-learning model can thus be trained and fine-tuned for different types of natural language operations such as text completion, dialogue generation, and content creation.

In some instances, the statement-extraction machine-learning model can be generated based on different types of machine-learning architectures. An example architecture used for transformer models can include a transformer model that includes an encoder and a decoder. Another example can include a Bidirectional Encoder Representations from Transformers (BERT), which is configured to understand the context of a word in search queries by considering the words on both its left and right.

In yet another example, a machine-learning architecture can include a Generative Pre-trained Transformer (GPT) that is trained using autoregressive language modeling and masked self-attention techniques. For example, the masked self-attention techniques can include masking future tokens when generating a contextual representation representing a given token, such that the contextual representation is determined only based on past tokens. The autoregressive language modeling techniques can then predict the next token of an output sequence based on the contextual representations of the text tokens.

An illustrative example process of training a GPT model is as follows. The masked self-attention process can begin by transforming each word in a given training text sequence into three vectors: the query (Q), key (K), and value (V) vectors. A Q vector can represent what information the token is querying about other tokens, a K vector can represent the token's context used to establish relationships with other tokens, and a V vector can represent the token's actual content/information. In some instances, the Q, K, and V vectors can be obtained by multiplying the input embeddings by learned weight matrices.

An attention score for a particular word can be calculated by taking the dot product of the Q vector of the word with the K vectors of all words in the sequence, thereby producing a score that reflects the relevance of each word pair. The attention scores can be used as weights, which can be applied to the Q, K, V vectors to generate a weighted contextual representation of the particular word. Stated differently, the attention score can be used as a weight to transform the Q, K, V vectors of a given word to generate a weighted, computed representation that can be used to train the corresponding GPT model.

In some instances, a mask can be applied to the self-attention mechanism such that a contextual representation of a given token is determined without weights associated with future tokens. As a result, an attention score of a particular token can be adjusted to disregard information from tokens that have not been processed yet. The attention scores can then be scaled by the square root of the key dimension to stabilize training and passed through a softmax function to convert the attention scores into probabilities, ensuring they sum to one. The transformation can identify the most relevant words while downplaying less important ones. The resulting attention weights can then be used to compute a weighted sum of the V vectors, thus producing a new contextual representation for each token that incorporates contextual information from the entire sequence.

To enhance the model's ability to capture various types of relationships, self-attention mechanisms can use multiple sets of Q, K, and V matrices, also referred to as multi-head attention. Each set, or head, can learn different aspects of the relationships within the input data. The outputs from these heads can be concatenated and linearly transformed to form the final self-attention output. This multi-head approach allows the transformer models to simultaneously consider different features and interactions, enriching its understanding of the input sequence.

The GPT model can then be trained using autoregressive language modeling to predict a subsequent token of a target sequence based on the contextual representations that represent the preceding tokens. For each position in the sequence, the GPT model accesses a contextual representation of the token, which was generated using masked self-attention mechanism. The GPT model can then output a probability distribution over a vocabulary for the subsequent token, conditioned on the sequence of preceding tokens. The subsequent token can then be compared with a corresponding token of the training data to calculate a loss. The loss measures the discrepancy between the predicted token and the actual token, providing a signal for the model to adjust its parameters. The loss can then be used to adjust parameters of the GPT model, including the parameters of the Q, K, V matrices.

Through iterative training iterations, the GPT model learns to minimize this loss across the entire training dataset. This process ensures that the model generates coherent and contextually appropriate sequences by leveraging the learned representations and adjusting its parameters based on the training data.

Other examples of machine-learning architectures can include: (1) a Text-to-Text Transfer Transformer (T5) that converts all natural-language processing tasks into a text-to-text format, unifying various tasks under a single model architecture; and (2) a Vision Transformer (ViT) that extends the transformer architecture to process longer text sequences and image data, respectively, thereby facilitating the corresponding model to be used across different domains.

### 3. Prompt Generator

A prompt generator 520 of the content-analysis system 502 can construct one or more filtering prompts for filtering the plurality of candidate hypothetical statements. As used herein, the term “prompt” can refer to as an input sequence generated to direct a corresponding machine-learning model's generation process towards producing a target output. In some instances, a filtering prompt includes a sequence of text tokens in a specific format (e.g., text, XML data, JSON data) and language (e.g., English, Korean).

For example, the one or more filtering prompts are used to filter the following candidate statements from the plurality of candidate hypothetical statements: (i) universally accepted statement of fact (e.g., “The Earth is a planet that orbits the Sun”); (ii) statements that are contextually irrelevant to the unstructured data (e.g., “The sky depicted in the image is blue”); and (iii) incomplete statements that provide insufficient information to qualify as a hypothetical statement (e.g., “The man is driving.”).

In some instances, the filtering prompts are machine-generated prompts that are generated by one or more computer systems without user intervention. For example, the one or more filtering prompts can be constructed using prompt engineering. Prompt engineering can include techniques for designing and implementing prompts within a machine-learning system (e.g., a natural-language processing (NLP) system) to generate target responses or actions. In some instances, prompt engineering leverages a combination of linguistic approaches, machine-learning algorithms, and domain knowledge to formulate prompts that elicit specific outputs from a corresponding machine-learning model. The prompt engineering process typically begins with an analysis of a target or a problem domain, followed by the formulation of prompts tailored to achieve the desired results.

As an illustrative example for optimizing prompts, a prompt P can be defined as a sequence of tokens, tailored to elicit specific responses from a machine-learning model (e.g., the statement-extraction machine-learning model). The model employs an objective function O(P, R) to evaluate the quality of generated responses R given the prompt P. The responses R can be generated based on a machine-learning language model LM processing the prompt P (e.g., the function LM(P)). Different types of objective functions can be selected depending on the task and targeted output. For example, an objective function can correspond to a text summarization technique using ROUGE scores. In another example, the objective function can correspond to a translation quality assessment technique using BLEU scores. In some instances, optimization techniques like gradient descent or evolutionary algorithms are used iteratively refine the prompt P to maximize O(P,R), to facilitate the model to consistently produce accurate, relevant, and contextually appropriate outputs (e.g., the hypothetical statements from the input data). For example, the optimal prompt P* can be determine based on maximizing the objective function O:

$$P *= argmax O ( P , LM ( P ) ) \qquad Equation ( 1 )$$

Through the iterative refinement process, prompt engineering enhances the corresponding model's performance across various natural language processing tasks, such as generating hypothetical statements that are contextually relevant to the input data.

In some instances, prompt engineering includes a selection of input formats and structures. The input-format selection can include determining the syntactic and semantic characteristics of the prompts that will effectively guide the machine-learning model towards the desired outputs. In some instances, linguistics and computational linguistics can be used to select input formats that are semantically meaningful and contextually relevant. The input-format selection can ensure that the prompts effectively communicate the desired tasks or questions to the machine-learning model. The prompt engineering process can also include an optimization of prompt parameters. The optimization can include fine-tuning various parameters such as prompt length, complexity, and specificity to enhance the machine-learning model's performance on targeted tasks. Different prompt formulations and configurations such as grid search or Bayesian optimization can be implemented to optimize the prompt parameters. Additionally or alternatively, techniques such as zero-shot learning or few-shot learning can be implemented to fine-tune the machine-learning models to generalize from limited prompt examples.

The prompt engineering process can be configured based on an underlying machine-learning model architecture and training data. For example, an appropriate pre-trained machine-learning model architecture (e.g., GPT, BERT, or Transformer) that aligns with the task requirements and available computational resources can be identified for a given task. In some instances, the machine-learning model can be fine-tuned on task-specific data to further improve probability of outputting target responses. Various types of training datasets can be used to train and fine-tune the machine-learning model, so as to enable the machine-learning model to understand and generate responses to prompts accurately.

In some instances, an iterative process of designing, testing, and optimizing prompts is implemented based on feedback from initial model outputs. This iterative approach allows for continuous improvement and refinement of the prompt engineering process, ultimately leading to better-performing machine-learning models. Additionally or alternatively, ongoing monitoring and evaluation of model performance can be used to identify any errors or biases introduced by the prompts and prompt engineering process, in which the feedback data can be generated based on the evaluation. The feedback data can be used to further adjust the parameters of the machine-learning models, such that the machine-learning models can be updated to improve accuracy in generating the target responses.

### 4. Statement Extractor

A statement extractor 522 of the content-analysis system 502 can process the one or more filtering prompts and the plurality of candidate hypothetical statements using the statement-extraction machine-learning model to identify one or more hypothetical statements. As previously described herein, the term “hypothetical statement” can refer to a statement or assertion of fact that excludes sufficient substantiation, evidence, or proof. In some instances, the hypothetical statement includes one or more declarations of belief, opinion, or fact that are yet to be verified.

In some instances, the statement extractor 522 can merge the one or more filtering prompts with the input data and the plurality of candidate hypothetical statements, in which the merged data can be used as a single input to the statement-extraction machine-learning model. For example, the one or more filtering prompts can be constructed and processed by the statement-extraction machine-learning model to identify the one or more hypothetical statements:

You are tasked with evaluating the following candidate statements based on specific criteria. Here are the criteria you need to consider for each statement:
1. Is the statement universally accepted statement of fact?
2. Is the statement contextually irrelevant to input data?
3. Does the statement provide insufficient information to qualify as a hypothetical statement?

The above-referenced input data is provided as follows:
/*input data*/

Please select one or more of the following statements that does not meet any of the above criteria.

###Statements to Evaluate:
1./*Candidate statement #1*/
2./*Candidate statement #2*/
3./*Candidate statement #3*/
4./*Candidate statement #4*/

The statement extractor 522 can tokenize the merged data input a sequence of text tokens. For example, the merged data can be tokenized to provide the following sequence: [“You”, “are”, “an”, “assistant”, “tasked”, . . . ]. In some instances, the statement-extraction machine-learning model uses Byte Pair Encoding (BPE) techniques to further split a single token (e.g., “in”, “sufficient”).

The statement extractor 522 can assign each token with a particular index value in the vocabulary (e.g., “assistant”=E[5]). Then, the statement extractor 522 can convert each token into a vector representation (e.g., an embedding) based on a pre-trained embedding matrix. For example, for a vocabulary size V and embedding dimension dᵢ, the embedding matrix E is of size V×d, in which the vector eᵢ can be generated for the text token tᵢ based on using the index value a looking of a corresponding row of embedding matrix E.

$$E : {e}_{i} = E [ {t}_{i} ] \qquad Equation ( 2 )$$

The statement extractor 522 can then process the sequence of embeddings (e₁, e₂, e₃, . . . eₙ) that represent the sequence of tokens by adding positional encodings to account for the order of tokens. In some instances, positional encodings are vectors added to each token embedding to inject information about the position of tokens in the sequence. A matrix X can be formed that includes the sequence of position-encoded vectors.

For the matrix X, the statement extractor 522 can then determine a contextual representation for each position-encoded vector of the matrix X. In particular, for each position-encoded vector, the statement extractor 522 can generate a set of Q, K, V vectors for the position-encoded vector. As described herein, a Q vector can represent what information the token is querying about other tokens, a K vector can represent the token's context used to establish relationships with other tokens, and a V vector can represent the token's actual content/information.

In some instances, to enhance the model's ability to capture various types of relationships, the position-encoded vector can be represented by multiple sets of Q, K, and V matrices (i.e., multi-head attention). Each set of Q, K, V vectors, or head, can learn different aspects of the relationships within the input data. The outputs from these heads can be concatenated and linearly transformed to form the final self-attention output. This multi-head approach allows the transformer models to simultaneously consider different features and interactions, enriching its understanding of the input sequence.

An attention score can be calculated for the set of Q, K, V vectors as follows:

$$Attention ( Q , K , V ) = softmax ( ( {QK}^{T} ) / √ ( {d}_{k} ) ) V \qquad Equation ( 3 )$$

The (QK^{T})/√(dₖ) can be used to compute the raw attention scores, in which dₖ is the dimensionality of the key vectors. Then, the softmax function is applied to the raw attention score to normalize it into a probability distribution. The statement extractor 522 can apply the attention score to a V vector of the corresponding set of Q, K, V vectors, such that the weighted Q, K, V vectors can be used as the contextual representation of the position-encoded vector of matrix X. In the instances in which multi-head attention is used, the multiple sets of weighted Q, K, V vectors can be concatenated and linearly transformed using a weight matrix W^{O} to generate the contextual representation of the position-encoded vector. The above process can be iterated through other position-encoded vectors of matrix X to generate a set of contextual representations associated with the merged data.

The statement extractor 522 can then apply the statement-extraction machine-learning model to the set of contextual representations to select one or more hypothetical statements from the plurality of candidate hypothetical statements. In particular, the statement-extraction machine-learning model can process the set of contextual representations to predict each token of the output, in which the outputted tokens can correspond to the selected hypothetical statements.

### 5. Output Module

An output module 524 of the content-analysis system 502 can transmit the summary data 526 of the input data 506 and the one or more hypothetical statements 528. In some instances, one or more additional modules of the content-analysis system 502 (not shown) further process the summary data 526 and the one or more hypothetical statements 528 using a context-determination machine-learning model to generate contextual data associated with the input data 506. For example, the content-analysis system 502 can further process the contextual data to determine whether the unstructured data includes unverified or misleading information.

In some instances, the content-analysis system 502 includes a retrieval-augmentation system that can access background data from one or more external databases (e.g., knowledgebase), in which the background data includes additional information associated with the unstructured data. The content-analysis system 502 can then generate the contextual data further based on the background data. The one or more external databases can store verification data for the hypothetical statements generated by the statement-extraction machine-learning model. In some instances, the one or more external databases are continuous updated using real-time data.

In some instances, the statement-extraction machine-learning model and the context-determination machine-learning model correspond to the same machine-learning model (e.g., a transformer model). Additionally or alternatively, the statement-extraction machine-learning model can be different from the context-determination machine-learning model.

### C. Methods

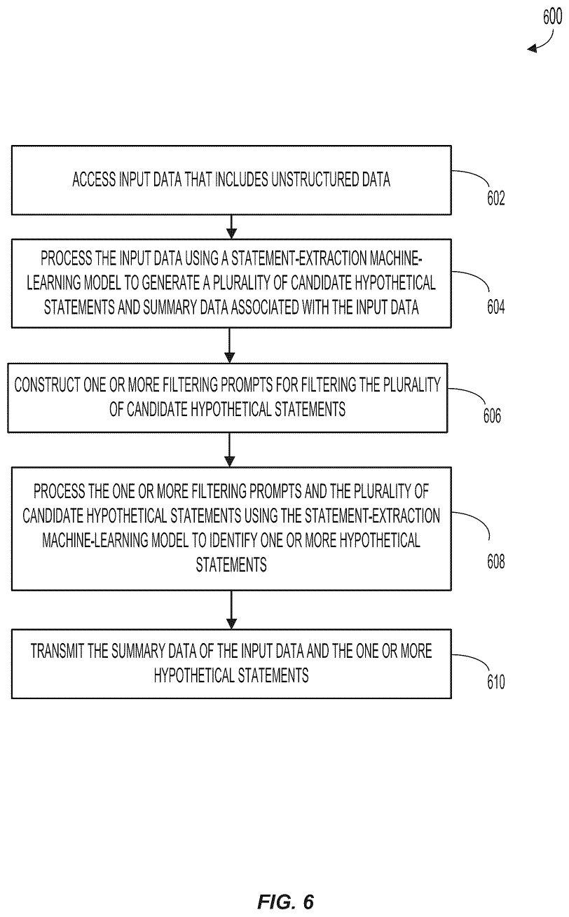

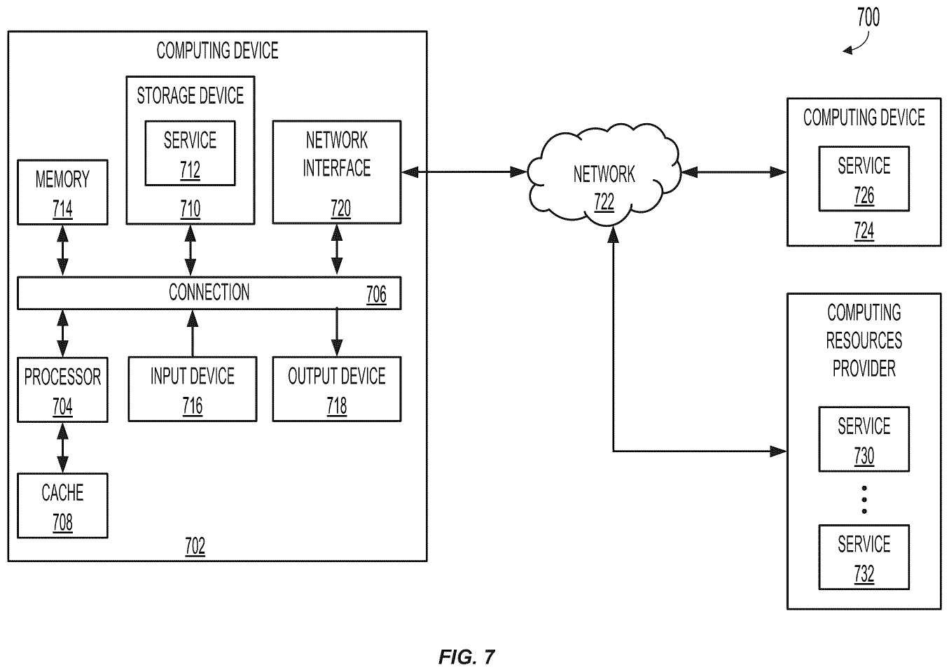

FIG. 6 shows an illustrative example of a process 600 for extracting hypothetical statements from unstructured data, in accordance with some embodiments. For illustrative purposes, the process 600 is described with reference to the components illustrated in FIGS. 1-2, though other implementations are possible. For example, the program code for the content-analysis system 502 of FIG. 2, is executed by one or more processing devices to cause a server system (e.g., the computing device 702 of FIG. 7) to perform one or more operations described herein.

At step 602, the content-analysis system accesses input data. In some instances, the input data includes unstructured data. The unstructured data can include image data, video data, audio data, three-dimensional data, hypertext data, computer-readable code, geo-location data, time data, medical data, sensor data, or any combinations thereof. In some instances, the unstructured data includes multi-modal inputs such as video data and text data. The hypothetical statements can thus be extracted based on processing both the video data and the text data. The multi-modal inputs can involve the integration of various types of data, such as the text data, the image data, the audio data, and the video data, such that the inputs can be processed by one or more machine learning systems. The multi-modal approach allows the ensuing machine-learning models to process and analyze information from diverse sources simultaneously, thus providing better context associated with the input data.

At step 604, the content-analysis system processes the input data using a statement-extraction machine-learning model to generate a plurality of candidate hypothetical statements and summary data associated with the input data. In some instances, the statement-extraction machine-learning model is fine-tuned using in-context learning with few-shots technique. In-context learning with the few-shots technique includes the machine-learning model learning and adapting to new tasks based on a small number of examples directly in the input text, rather than using conventional training or fine-tuning processes. The in-context learning with few-shots approach leverages the statement-extraction machine-learning model model's extensive pre-trained knowledge and its ability to recognize patterns and relationships within the provided context.

In some instances, if the unstructured data includes image data, the candidate-statement generator can apply the statement-extraction machine-learning model to the image data to generate an image-based candidate hypothetical statement. The image-based candidate hypothetical statement can include a description of one or more image objects depicted in the image data. In some instances, the description includes identifying a person or an entity associated with the one or more image objects (e.g., logos indicating a particular entity). Additionally or alternatively, the image-based candidate hypothetical statement can be generated to include a classification of whether the image data includes machine-generated images. The detection of machine-generated images can be used to determine whether a particular hypothetical statement is substantiated or unsubstantiated with evidence.

In some instances, if the unstructured data includes video data, the candidate-statement generator can apply the statement-extraction machine-learning model to the video data to generate a video-based candidate hypothetical statement. The video-based candidate hypothetical statement can include a description of one or more video objects streamed on the video data. Additionally or alternatively, the video-based candidate hypothetical statement can be generated to also include a classification of whether the video data includes machine-generated videos.

In some instances, if the unstructured data includes audio data, the content-analysis system can apply the statement-extraction machine-learning model to the audio data to generate an audio-based candidate hypothetical statement. The audio-based candidate hypothetical statement can include a description of one or more objects specified in the audio data. Similar to image-based and video-based hypothetical statements, the audio-based candidate hypothetical statement can also include a classification of whether the audio data includes machine-generated audio.

In some instances, the statement-extraction machine-learning model can process multi-modal input data (e.g., video and text, image and text). As an example implementation, the statement-extraction machine-learning model can be configured as a single vision-language model that is trained and fine-tuned to directly process multiple modalities to generate the plurality of candidate hypothetical statements and the summary data. In another example implementation, the statement-extraction machine-learning model can be configured as multiple machine-learning models, in which each machine-learning model is trained and fine-tuned to process a corresponding type of modality.

At step 606, the content-analysis system constructs one or more filtering prompts for filtering the plurality of candidate hypothetical statements. In some instances, a filtering prompt includes a sequence of text tokens in a specific format (e.g., text, XML data, JSON data) and language (e.g., English, Korean). For example, the one or more filtering prompts are used to filter the following candidate statements from the plurality of candidate hypothetical statements: (i) universally accepted statement of fact (e.g., “The Earth is a planet that orbits the Sun”); (ii) statements that are contextually irrelevant to the unstructured data (e.g., “The sky depicted in the image is blue”); and (iii) incomplete statements that provide insufficient information to qualify as a hypothetical statement (e.g., “The man is driving.”).

At step 608, the content-analysis system processes the one or more filtering prompts and the plurality of candidate hypothetical statements using the statement-extraction machine-learning model to identify one or more hypothetical statements. In some instances, the one or more hypothetical statements correspond to one or more non-factual assertions associated with the unstructured data.

At step 610, the content-analysis system transmits the summary data of the input data and the one or more hypothetical statements. In some instances, the summary data of the input data and the one or more hypothetical statements are processed using a context-determination machine-learning model to generate contextual data associated with the input data. The contextual data can be processed to determine whether the unstructured data includes unverified or misleading information. In some instances, the content-analysis system accesses background data from one or more external databases, in which the background data includes additional information that describes at least part of the unstructured data. The content-analysis system can then generate the contextual data further based on the background data.

In some instances, the statement-extraction machine-learning model and the context-determination machine-learning model correspond to the same machine-learning model (e.g., a transformer model). Additionally or alternatively, the statement-extraction machine-learning model is different from the context-determination machine-learning model. Process 600 terminates thereafter.

### III. Example Systems

FIG. 7 illustrates a computing system architecture 700, including various components in electrical communication with each other, in accordance with some embodiments. The example computing system architecture 700 illustrated in FIG. 7 includes a computing device 702, which has various components in electrical communication with each other using a connection 706, such as a bus, in accordance with some implementations. The example computing system architecture 700 includes a processing unit 704 that is in electrical communication with various system components, using the connection 706, and including the system memory 714. In some embodiments, the system memory 714 includes read-only memory (ROM), random-access memory (RAM), and other such memory technologies including, but not limited to, those described herein. In some embodiments, the example computing system architecture 700 includes a cache 708 of high-speed memory connected directly with, in close proximity to, or integrated as part of the processor 704. The system architecture 700 can copy data from the memory 714 and/or the storage device 710 to the cache 708 for quick access by the processor 704. In this way, the cache 708 can provide a performance boost that decreases or eliminates processor delays in the processor 704 due to waiting for data. Using modules, methods and services such as those described herein, the processor 704 can be configured to perform various actions. In some embodiments, the cache 708 may include multiple types of cache including, for example, level one (L1) and level two (L2) cache. The memory 714 may be referred to herein as system memory or computer system memory. The memory 714 may include, at various times, elements of an operating system, one or more applications, data associated with the operating system or the one or more applications, or other such data associated with the computing device 702.

Other system memory 714 can be available for use as well. The memory 714 can include multiple different types of memory with different performance characteristics. The processor 704 can include any general purpose processor and one or more hardware or software services, such as service 712 stored in storage device 710, configured to control the processor 704 as well as a special-purpose processor where software instructions are incorporated into the actual processor design. The processor 704 can be a completely self-contained computing system, containing multiple cores or processors, connectors (e.g., buses), memory, memory controllers, caches, etc. In some embodiments, such a self-contained computing system with multiple cores is symmetric. In some embodiments, such a self-contained computing system with multiple cores is asymmetric. In some embodiments, the processor 704 can be a microprocessor, a microcontroller, a digital signal processor (“DSP”), or a combination of these and/or other types of processors. In some embodiments, the processor 704 can include multiple elements such as a core, one or more registers, and one or more processing units such as an arithmetic logic unit (ALU), a floating point unit (FPU), a graphics processing unit (GPU), a physics processing unit (PPU), a digital system processing (DSP) unit, or combinations of these and/or other such processing units.

To enable user interaction with the computing system architecture 700, an input device 716 can represent any number of input mechanisms, such as a microphone for speech, a touch-sensitive screen for gesture or graphical input, keyboard, mouse, motion input, pen, and other such input devices. An output device 718 can also be one or more of a number of output mechanisms known to those of skill in the art including, but not limited to, monitors, speakers, printers, haptic devices, and other such output devices. In some instances, multimodal systems can enable a user to provide multiple types of input to communicate with the computing system architecture 700. In some embodiments, the input device 716 and/or the output device 718 can be coupled to the computing device 702 using a remote connection device such as, for example, a communication interface such as the network interface 720 described herein. In such embodiments, the communication interface can govern and manage the input and output received from the attached input device 716 and/or output device 718. As may be contemplated, there is no restriction on operating on any particular hardware arrangement and accordingly the basic features here may easily be substituted for other hardware, software, or firmware arrangements as they are developed.

In some embodiments, the storage device 710 can be described as non-volatile storage or non-volatile memory. Such non-volatile memory or non-volatile storage can be a hard disk or other types of computer readable media which can store data that are accessible by a computer, such as magnetic cassettes, flash memory cards, solid state memory devices, digital versatile disks, cartridges, RAM, ROM, and hybrids thereof.

As described above, the storage device 710 can include hardware and/or software services such as service 712 that can control or configure the processor 704 to perform one or more functions including, but not limited to, the methods, processes, functions, systems, and services described herein in various embodiments. In some embodiments, the hardware or software services can be implemented as modules. As illustrated in example computing system architecture 700, the storage device 710 can be connected to other parts of the computing device 702 using the system connection 706. In some embodiments, a hardware service or hardware module such as service 712, that performs a function can include a software component stored in a non-transitory computer-readable medium that, in connection with the necessary hardware components, such as the processor 704, connection 706, cache 708, storage device 710, memory 714, input device 716, output device 718, and so forth, can carry out the functions such as those described herein.

The disclosed systems and service of a content-analysis system (e.g., the content-analysis system 402 described herein at least in connection with FIG. 4) can be performed using a computing system such as the example computing system illustrated in FIG. 7, using one or more components of the example computing system architecture 700. An example computing system can include a processor (e.g., a central processing unit), memory, non-volatile memory, and an interface device. The memory may store data and/or and one or more code sets, software, scripts, etc. The components of the computer system can be coupled together via a bus or through some other known or convenient device.

In some embodiments, the processor can be configured to carry out some or all of methods and systems for extracting hypothetical statements from unstructured data associated with the content-analysis system (e.g., the content-analysis system 402 described herein at least in connection with FIG. 4) described herein by, for example, executing code using a processor such as processor 704 wherein the code is stored in memory such as memory 714 as described herein. One or more of a user device, a provider server or system, a database system, or other such devices, services, or systems may include some or all of the components of the computing system such as the example computing system illustrated in FIG. 7, using one or more components of the example computing system architecture 700 illustrated herein. As may be contemplated, variations on such systems can be considered as within the scope of the present disclosure.

This disclosure contemplates the computer system taking any suitable physical form. As example and not by way of limitation, the computer system can be an embedded computer system, a system-on-chip (SOC), a single-board computer system (SBC) (such as, for example, a computer-on-module (COM) or system-on-module (SOM)), a desktop computer system, a laptop or notebook computer system, a tablet computer system, a wearable computer system or interface, an interactive kiosk, a mainframe, a mesh of computer systems, a mobile telephone, a personal digital assistant (PDA), a server, or a combination of two or more of these. Where appropriate, the computer system may include one or more computer systems; be unitary or distributed; span multiple locations; span multiple machines; and/or reside in a cloud computing system which may include one or more cloud components in one or more networks as described herein in association with the computing resources provider 728. Where appropriate, one or more computer systems may perform without substantial spatial or temporal limitation one or more steps of one or more methods described or illustrated herein. As an example and not by way of limitation, one or more computer systems may perform in real time or in batch mode one or more steps of one or more methods described or illustrated herein. One or more computer systems may perform at different times or at different locations one or more steps of one or more methods described or illustrated herein, where appropriate.

The processor 704 can be a conventional microprocessor such as an Intel® microprocessor, an AMD® microprocessor, a Motorola® microprocessor, or other such microprocessors. One of skill in the relevant art will recognize that the terms “machine-readable (storage) medium” or “computer-readable (storage) medium” include any type of device that is accessible by the processor.

The memory 714 can be coupled to the processor 704 by, for example, a connector such as connector 706, or a bus. As used herein, a connector or bus such as connector 706 is a communications system that transfers data between components within the computing device 702 and may, in some embodiments, be used to transfer data between computing devices. The connector 706 can be a data bus, a memory bus, a system bus, or other such data transfer mechanism. Examples of such connectors include, but are not limited to, an industry standard architecture (ISA″ bus, an extended ISA (EISA) bus, a parallel AT attachment (PATA″ bus (e.g., an integrated drive electronics (IDE) or an extended IDE (EIDE) bus), or the various types of parallel component interconnect (PCI) buses (e.g., PCI, PCIe, PCI-104, etc.).

The memory 714 can include RAM including, but not limited to, dynamic RAM (DRAM), static RAM (SRAM), synchronous dynamic RAM (SDRAM), non-volatile random access memory (NVRAM), and other types of RAM. The DRAM may include error-correcting code (EEC). The memory can also include ROM including, but not limited to, programmable ROM (PROM), erasable and programmable ROM (EPROM), electronically erasable and programmable ROM (EEPROM), Flash Memory, masked ROM (MROM), and other types or ROM. The memory 714 can also include magnetic or optical data storage media including read-only (e.g., CD ROM and DVD ROM) or otherwise (e.g., CD or DVD). The memory can be local, remote, or distributed.

As described above, the connector 706 (or bus) can also couple the processor 704 to the storage device 710, which may include non-volatile memory or storage and which may also include a drive unit. In some embodiments, the non-volatile memory or storage is a magnetic floppy or hard disk, a magnetic-optical disk, an optical disk, a ROM (e.g., a CD-ROM, DVD-ROM, EPROM, or EEPROM), a magnetic or optical card, or another form of storage for data. Some of this data may be written, by a direct memory access process, into memory during execution of software in a computer system. The non-volatile memory or storage can be local, remote, or distributed. In some embodiments, the non-volatile memory or storage is optional. As may be contemplated, a computing system can be created with all applicable data available in memory. A typical computer system will usually include at least one processor, memory, and a device (e.g., a bus) coupling the memory to the processor.

Software and/or data associated with software can be stored in the non-volatile memory and/or the drive unit. In some embodiments (e.g., for large programs) it may not be possible to store the entire program and/or data in the memory at any one time. In such embodiments, the program and/or data can be moved in and out of memory from, for example, an additional storage device such as storage device 710. Nevertheless, it should be understood that for software to run, if necessary, it is moved to a computer readable location appropriate for processing, and for illustrative purposes, that location is referred to as the memory herein. Even when software is moved to the memory for execution, the processor can make use of hardware registers to store values associated with the software, and local cache that, ideally, serves to speed up execution. As used herein, a software program is assumed to be stored at any known or convenient location (from non-volatile storage to hardware registers), when the software program is referred to as “implemented in a computer-readable medium.” A processor is considered to be “configured to execute a program” when at least one value associated with the program is stored in a register readable by the processor.

The connection 706 can also couple the processor 704 to a network interface device such as the network interface 720. The interface can include one or more of a modem or other such network interfaces including, but not limited to those described herein. It will be appreciated that the network interface 720 may be considered to be part of the computing device 702 or may be separate from the computing device 702. The network interface 720 can include one or more of an analog modem, Integrated Services Digital Network (ISDN) modem, cable modem, token ring interface, satellite transmission interface, or other interfaces for coupling a computer system to other computer systems. In some embodiments, the network interface 720 can include one or more input and/or output (I/O) devices. The I/O devices can include, by way of example but not limitation, input devices such as input device 716 and/or output devices such as output device 718. For example, the network interface 720 may include a keyboard, a mouse, a printer, a scanner, a display device, and other such components. Other examples of input devices and output devices are described herein. In some embodiments, a communication interface device can be implemented as a complete and separate computing device.

In operation, the computer system can be controlled by operating system software that includes a file management system, such as a disk operating system. One example of operating system software with associated file management system software is the family of Windows® operating systems and their associated file management systems. Another example of operating system software with its associated file management system software is the Linux™ operating system and its associated file management system including, but not limited to, the various types and implementations of the Linux® operating system and their associated file management systems. The file management system can be stored in the non-volatile memory and/or drive unit and can cause the processor to execute the various acts required by the operating system to input and output data and to store data in the memory, including storing files on the non-volatile memory and/or drive unit. As may be contemplated, other types of operating systems such as, for example, MacOS®, other types of UNIX® operating systems (e.g., BSD™ and descendants, Xenix™, SunOS™, HP-UX®, etc.), mobile operating systems (e.g., iOS® and variants, Chrome®, Ubuntu Touch®, watchOS®, Windows 10 Mobile®, the Blackberry® OS, etc.), and real-time operating systems (e.g., Vx Works®, QNX®, cCos®, RTLinux®, etc.) may be considered as within the scope of the present disclosure. As may be contemplated, the names of operating systems, mobile operating systems, real-time operating systems, languages, and devices, listed herein may be registered trademarks, service marks, or designs of various associated entities.

In some embodiments, the computing device 702 can be connected to one or more additional computing devices such as computing device 724 via a network 722 using a connection such as the network interface 720. In such embodiments, the computing device 724 may execute one or more services 726 to perform one or more functions under the control of, or on behalf of, programs and/or services operating on computing device 702. In some embodiments, a computing device such as computing device 724 may include one or more of the types of components as described in connection with computing device 702 including, but not limited to, a processor such as processor 704, a connection such as connection 706, a cache such as cache 708, a storage device such as storage device 710, memory such as memory 714, an input device such as input device 716, and an output device such as output device 718. In such embodiments, the computing device 724 can carry out the functions such as those described herein in connection with computing device 702. In some embodiments, the computing device 702 can be connected to a plurality of computing devices such as computing device 724, each of which may also be connected to a plurality of computing devices such as computing device 724. Such an embodiment may be referred to herein as a distributed computing environment.

The network 722 can be any network including an internet, an intranet, an extranet, a cellular network, a Wi-Fi network, a local area network (LAN), a wide area network (WAN), a satellite network, a Bluetooth® network, a virtual private network (VPN), a public switched telephone network, an infrared (IR) network, an internet of things (IoT network) or any other such network or combination of networks. Communications via the network 722 can be wired connections, wireless connections, or combinations thereof. Communications via the network 722 can be made via a variety of communications protocols including, but not limited to, Transmission Control Protocol/Internet Protocol (TCP/IP), User Datagram Protocol (UDP), protocols in various layers of the Open System Interconnection (OSI) model, File Transfer Protocol (FTP), Universal Plug and Play (UPnP), Network File System (NFS), Server Message Block (SMB), Common Internet File System (CIFS), and other such communications protocols.

Communications over the network 722, within the computing device 702, within the computing device 724, or within the computing resources provider 728 can include information, which also may be referred to herein as content. The information may include text, graphics, audio, video, haptics, and/or any other information that can be provided to a user of the computing device such as the computing device 702. In some embodiments, the information can be delivered using a transfer protocol such as Hypertext Markup Language (HTML), Extensible Markup Language (XML), JavaScript®, Cascading Style Sheets (CSS), JavaScript® Object Notation (JSON), and other such protocols and/or structured languages. The information may first be processed by the computing device 702 and presented to a user of the computing device 702 using forms that are perceptible via sight, sound, smell, taste, touch, or other such mechanisms. In some embodiments, communications over the network 722 can be received and/or processed by a computing device configured as a server. Such communications can be sent and received using PHP: Hypertext Preprocessor (“PHP”), Python™, Ruby, Perl® and variants, Java®, HTML, XML, or another such server-side processing language.

In some embodiments, the computing device 702 and/or the computing device 724 can be connected to a computing resources provider 728 via the network 722 using a network interface such as those described herein (e.g. network interface 720). In such embodiments, one or more systems (e.g., service 730 and service 732) hosted within the computing resources provider 728 (also referred to herein as within “a computing resources provider environment”) may execute one or more services to perform one or more functions under the control of, or on behalf of, programs and/or services operating on computing device 702 and/or computing device 724. Systems such as service 730 and service 732 may include one or more computing devices such as those described herein to execute computer code to perform the one or more functions under the control of, or on behalf of, programs and/or services operating on computing device 702 and/or computing device 724.

For example, the computing resources provider 728 may provide a service, operating on service 730 to store data for the computing device 702 when, for example, the amount of data that the computing device 702 exceeds the capacity of storage device 710. In another example, the computing resources provider 728 may provide a service to first instantiate a virtual machine (VM) on service 732, use that VM to access the data stored on service 732, perform one or more operations on that data, and provide a result of those one or more operations to the computing device 702. Such operations (e.g., data storage and VM instantiation) may be referred to herein as operating “in the cloud,” “within a cloud computing environment,” or “within a hosted virtual machine environment,” and the computing resources provider 728 may also be referred to herein as “the cloud.” Examples of such computing resources providers include, but are not limited to Amazon® Web Services (AWS®), Microsoft's Azure®, IBM Cloud®, Google Cloud®, Oracle Cloud® etc.

Services provided by a computing resources provider 728 include, but are not limited to, data analytics, data storage, archival storage, big data storage, virtual computing (including various scalable VM architectures), blockchain services, containers (e.g., application encapsulation), database services, development environments (including sandbox development environments), e-commerce solutions, game services, media and content management services, security services, server-less hosting, virtual reality (VR) systems, and augmented reality (AR) systems. Various techniques to facilitate such services include, but are not be limited to, virtual machines, virtual storage, database services, system schedulers (e.g., hypervisors), resource management systems, various types of short-term, mid-term, long-term, and archival storage devices, etc.

As may be contemplated, the systems such as service 730 and service 732 may implement versions of various services (e.g., the service 712 or the service 726) on behalf of, or under the control of, computing device 702 and/or computing device 724. Such implemented versions of various services may involve one or more virtualization techniques so that, for example, it may appear to a user of computing device 702 that the service 712 is executing on the computing device 702 when the service is executing on, for example, service 730. As may also be contemplated, the various services operating within the computing resources provider 728 environment may be distributed among various systems within the environment as well as partially distributed onto computing device 724 and/or computing device 702.

Client devices, user devices, computer resources provider devices, network devices, and other devices can be computing systems that include one or more integrated circuits, input devices, output devices, data storage devices, and/or network interfaces, among other things. The integrated circuits can include, for example, one or more processors, volatile memory, and/or non-volatile memory, among other things such as those described herein. The input devices can include, for example, a keyboard, a mouse, a key pad, a touch interface, a microphone, a camera, and/or other types of input devices including, but not limited to, those described herein. The output devices can include, for example, a display screen, a speaker, a haptic feedback system, a printer, and/or other types of output devices including, but not limited to, those described herein. A data storage device, such as a hard drive or flash memory, can enable the computing device to temporarily or permanently store data. A network interface, such as a wireless or wired interface, can enable the computing device to communicate with a network. Examples of computing devices (e.g., the computing device 702) include, but is not limited to, desktop computers, laptop computers, server computers, hand-held computers, tablets, smart phones, personal digital assistants, digital home assistants, wearable devices, smart devices, and combinations of these and/or other such computing devices as well as machines and apparatuses in which a computing device has been incorporated and/or virtually implemented.

The techniques described herein may also be implemented in electronic hardware, computer software, firmware, or any combination thereof. Such techniques may be implemented in any of a variety of devices such as general purpose computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as that described herein. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices (e.g., a combination of a DSP and a microprocessor), a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for implementing a suspended database update system.

As used herein, the term “machine-readable media” and equivalent terms “machine-readable storage media,” “computer-readable media,” and “computer-readable storage media” refer to media that includes, but is not limited to, portable or non-portable storage devices, optical storage devices, removable or non-removable storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), solid state drives (SSD), flash memory, memory or memory devices.

A machine-readable medium or machine-readable storage medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like. Further examples of machine-readable storage media, machine-readable media, or computer-readable (storage) media include but are not limited to recordable type media such as volatile and non-volatile memory devices, floppy and other removable disks, hard disk drives, optical disks (e.g., CDs, DVDs, etc.), among others, and transmission type media such as digital and analog communication links.

As may be contemplated, while examples herein may illustrate or refer to a machine-readable medium or machine-readable storage medium as a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding, or carrying a set of instructions for execution by the system and that cause the system to perform any one or more of the methodologies or modules of disclosed herein.

Some portions of the detailed description herein may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within registers and memories of the computer system into other data similarly represented as physical quantities within the computer system memories or registers or other such information storage, transmission or display devices.

It is also noted that individual implementations may be described as a process which is depicted as a flowchart, a flow diagram, a data flow diagram, a structure diagram, or a block diagram (e.g., the example process 600 of FIG. 6). Although a flowchart, a flow diagram, a data flow diagram, a structure diagram, or a block diagram may describe the operations as a sequential process, many of the operations can be performed in parallel or concurrently. In addition, the order of the operations may be re-arranged. A process illustrated in a figure is terminated when its operations are completed, but could have additional steps not included in the figure. A process may correspond to a method, a function, a procedure, a subroutine, a subprogram, etc. When a process corresponds to a function, its termination can correspond to a return of the function to the calling function or the main function.

In some embodiments, one or more implementations of an algorithm such as those described herein may be implemented using a machine learning or artificial intelligence algorithm. Such a machine learning or artificial intelligence algorithm may be trained using supervised, unsupervised, reinforcement, or other such training techniques. For example, a set of data may be analyzed using one of a variety of machine learning algorithms to identify correlations between different elements of the set of data without supervision and feedback (e.g., an unsupervised training technique). A machine learning data analysis algorithm may also be trained using sample or live data to identify potential correlations. Such algorithms may include k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Other examples of machine learning or artificial intelligence algorithms include, but are not limited to, genetic algorithms, backpropagation, reinforcement learning, decision trees, liner classification, artificial neural networks, anomaly detection, and such. More generally, machine learning or artificial intelligence methods may include regression analysis, dimensionality reduction, metalearning, reinforcement learning, deep learning, and other such algorithms and/or methods. As may be contemplated, the terms “machine learning” and “artificial intelligence” are frequently used interchangeably due to the degree of overlap between these fields and many of the disclosed techniques and algorithms have similar approaches.

As an example of a supervised training technique, a set of data can be selected for training of the machine learning model to facilitate identification of correlations between members of the set of data. The machine learning model may be evaluated to determine, based on the sample inputs supplied to the machine learning model, whether the machine learning model is producing accurate correlations between members of the set of data. Based on this evaluation, the machine learning model may be modified to increase the likelihood of the machine learning model identifying the desired correlations. The machine learning model may further be dynamically trained by soliciting feedback from users of a system as to the efficacy of correlations provided by the machine learning algorithm or artificial intelligence algorithm (i.e., the supervision). The machine learning algorithm or artificial intelligence may use this feedback to improve the algorithm for generating correlations (e.g., the feedback may be used to further train the machine learning algorithm or artificial intelligence to provide more accurate correlations).

The various examples of flowcharts, flow diagrams, data flow diagrams, structure diagrams, or block diagrams discussed herein may further be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable storage medium (e.g., a medium for storing program code or code segments) such as those described herein. A processor(s), implemented in an integrated circuit, may perform the necessary tasks.

The various illustrative logical blocks, modules, circuits, and algorithm steps described in connection with the implementations disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

It should be noted, however, that the algorithms and displays presented herein are not inherently related to any particular computer or other apparatus. Various general purpose systems may be used with programs in accordance with the teachings herein, or it may prove convenient to construct more specialized apparatus to perform the methods of some examples. The required structure for a variety of these systems will appear from the description below. In addition, the techniques are not described with reference to any particular programming language, and various examples may thus be implemented using a variety of programming languages.

In various implementations, the system operates as a standalone device or may be connected (e.g., networked) to other systems. In a networked deployment, the system may operate in the capacity of a server or a client system in a client-server network environment, or as a peer system in a peer-to-peer (or distributed) network environment.

The system may be a server computer, a client computer, a personal computer (PC), a tablet PC (e.g., an iPad®, a Microsoft Surface®, a Chromebook®, etc.), a laptop computer, a set-top box (STB), a personal digital assistants (PDA), a mobile device (e.g., a cellular telephone, an iPhone®, and Android® device, a Blackberry®, etc.), a wearable device, an embedded computer system, an electronic book reader, a processor, a telephone, a web appliance, a network router, switch or bridge, or any system capable of executing a set of instructions (sequential or otherwise) that specify actions to be taken by that system. The system may also be a virtual system such as a virtual version of one of the aforementioned devices that may be hosted on another computer device such as the computer device 702.

In general, the routines executed to implement the implementations of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while examples have been described in the context of fully functioning computers and computer systems, those skilled in the art will appreciate that the various examples are capable of being distributed as a program object in a variety of forms, and that the disclosure applies equally regardless of the particular type of machine or computer-readable media used to actually effect the distribution.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting can appreciate that many modifications and variations are possible in light of the above disclosure and may be made thereto without departing from the broader scope of the embodiments as set forth herein. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, or any combination of the items in the list.

As used herein, the terms “a” and “an” and “the” and other such singular referents are to be construed to include both the singular and the plural, unless otherwise indicated herein or clearly contradicted by context.

As used herein, the terms “comprising,” “having,” “including,” and “containing” are to be construed as open-ended (e.g., “including” is to be construed as “including, but not limited to”), unless otherwise indicated or clearly contradicted by context.

As used herein, the recitation of ranges of values is intended to serve as a shorthand method of referring individually to each separate value falling within the range, unless otherwise indicated or clearly contradicted by context. Accordingly, each separate value of the range is incorporated into the specification as if it were individually recited herein.

As used herein, use of the terms “set” (e.g., “a set of items”) and “subset” (e.g., “a subset of the set of items”) is to be construed as a nonempty collection including one or more members unless otherwise indicated or clearly contradicted by context. Furthermore, unless otherwise indicated or clearly contradicted by context, the term “subset” of a corresponding set does not necessarily denote a proper subset of the corresponding set but that the subset and the set may include the same elements (i.e., the set and the subset may be the same).

As used herein, use of conjunctive language such as “at least one of A, B, and C” is to be construed as indicating one or more of A, B, and C (e.g., any one of the following nonempty subsets of the set {A, B, C}, namely: {A}, {B}, {C}, {A, B}, {A, C}, {B, C}, or {A, B, C}) unless otherwise indicated or clearly contradicted by context. Accordingly, conjunctive language such as “as least one of A, B, and C” does not imply a requirement for at least one of A, at least one of B, and at least one of C.

As used herein, the use of examples or exemplary language (e.g., “such as” or “as an example”) is intended to more clearly illustrate embodiments and does not impose a limitation on the scope unless otherwise claimed. Such language in the specification should not be construed as indicating any non-claimed element is required for the practice of the embodiments described and claimed in the present disclosure.

As used herein, where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described above. The elements and acts of the various examples described above can be combined to provide further examples.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further examples of the disclosure.

These and other changes can be made to the disclosure in light of the above Detailed Description. While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

While certain aspects of the disclosure are presented below in certain claim forms, the inventors contemplate the various aspects of the disclosure in any number of claim forms. Any claims intended to be treated under 45 U.S.C. § 112(f) will begin with the words “means for”. Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various examples given in this specification.

Without intent to further limit the scope of the disclosure, examples of instruments, apparatus, methods and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples may also relate to an object that is produced by a computing process described herein. Such an object may comprise information resulting from a computing process, where the information is stored on a non-transitory, tangible computer readable storage medium and may include any implementation of a computer program object or other data combination described herein.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

Specific details were given in the preceding description to provide a thorough understanding of various implementations of systems and components for a contextual connection system. It will be understood by one of ordinary skill in the art, however, that the implementations described above may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

What is claimed is:

1. A computer-implemented method comprising:
accessing input data, wherein the input data includes unstructured data;
processing the input data using a statement-extraction machine-learning model to generate a plurality of candidate hypothetical statements and summary data associated with the input data;
constructing one or more filtering prompts for filtering the plurality of candidate hypothetical statements;
processing the one or more filtering prompts and the plurality of candidate hypothetical statements using the statement-extraction machine-learning model to identify one or more hypothetical statements, wherein the one or more hypothetical statements correspond to one or more non-factual assertions associated with the unstructured data; and
transmitting the summary data of the input data and the one or more hypothetical statements, wherein the summary data of the input data and the one or more hypothetical statements are processed using a context-determination machine-learning model to generate contextual data associated with the input data.

2. The computer-implemented method of claim 1, wherein the unstructured data includes image data, video data, and/or audio data, three-dimensional data, hypertext data, computer-readable code, geo-location data, time data, medical data, and/or sensor data.

3. The computer-implemented method of claim 1, further comprising accessing background data from one or more external databases, wherein the background data includes additional information that describes at least part of the unstructured data, and wherein the contextual data is generated further based on the background data.

4. The computer-implemented method of claim 1, wherein the unstructured data includes image data, wherein generating the plurality of candidate hypothetical statements includes applying the statement-extraction machine-learning model to the image data to generate an image-based candidate hypothetical statement, wherein the image-based candidate hypothetical statement includes a description of one or more image objects depicted in the image data.

5. The computer-implemented method of claim 1, wherein the unstructured data includes image data, wherein generating the plurality of candidate hypothetical statements includes applying the statement-extraction machine-learning model to the image data to generate an image-based candidate hypothetical statement, wherein the image-based candidate hypothetical statement includes a classification of whether the image data includes machine-generated images.

6. The computer-implemented method of claim 1, wherein the unstructured data includes video data, wherein generating the plurality of candidate hypothetical statements includes applying the statement-extraction machine-learning model to the video data to generate a video-based candidate hypothetical statement, and wherein the video-based candidate hypothetical statement includes a description of one or more video objects streamed on the video data.

7. The computer-implemented method of claim 1, wherein the unstructured data includes audio data, wherein generating the plurality of candidate hypothetical statements includes applying the statement-extraction machine-learning model to the audio data to generate an audio-based candidate hypothetical statement, and wherein the audio-based candidate hypothetical statement includes a description of one or more objects specified in the audio data.

8. The computer-implemented method of claim 1, further comprising processing the contextual data to determine whether the unstructured data includes unverified or misleading information.

9. The computer-implemented method of claim 1, wherein the statement-extraction machine-learning model and the context-determination machine-learning model correspond to the same machine-learning model.

10. The computer-implemented method of claim 1, wherein the statement-extraction machine-learning model is different from the context-determination machine-learning model.

11. The computer-implemented method of claim 1, wherein the statement-extraction machine-learning model is fine-tuned using in-context learning with few-shots technique.

12. A system comprising:
one or more processors; and
memory storing thereon instructions that, as a result of being executed by the one or more processors, cause the system to perform operations comprising:
accessing input data, wherein the input data includes unstructured data;
processing the input data using a statement-extraction machine-learning model to generate a plurality of candidate hypothetical statements and summary data associated with the input data;
constructing one or more filtering prompts for filtering the plurality of candidate hypothetical statements;
processing the one or more filtering prompts and the plurality of candidate hypothetical statements using the statement-extraction machine-learning model to identify one or more hypothetical statements, wherein the one or more hypothetical statements correspond to one or more non-factual assertions associated with the unstructured data; and
transmitting the summary data of the input data and the one or more hypothetical statements, wherein the summary data of the input data and the one or more hypothetical statements are processed using a context-determination machine-learning model to generate contextual data associated with the input data.

13. The system of claim 12, wherein the unstructured data includes image data, wherein generating the plurality of candidate hypothetical statements includes applying the statement-extraction machine-learning model to the image data to generate an image-based candidate hypothetical statement, wherein the image-based candidate hypothetical statement includes a description of one or more image objects depicted in the image data.

14. The system of claim 12, wherein the unstructured data includes image data, wherein generating the plurality of candidate hypothetical statements includes applying the statement-extraction machine-learning model to the image data to generate an image-based candidate hypothetical statement, wherein the image-based candidate hypothetical statement includes a classification of whether the image data includes machine-generated images.

15. The system of claim 12, wherein the unstructured data includes video data, wherein generating the plurality of candidate hypothetical statements includes applying the statement-extraction machine-learning model to the video data to generate a video-based candidate hypothetical statement, and wherein the video-based candidate hypothetical statement includes a description of one or more video objects streamed on the video data.

16. The system of claim 12, wherein the unstructured data includes audio data, wherein generating the plurality of candidate hypothetical statements includes applying the statement-extraction machine-learning model to the audio data to generate an audio-based candidate hypothetical statement, and wherein the audio-based candidate hypothetical statement includes a description of one or more objects specified in the audio data.

17. A non-transitory, computer-readable storage medium storing thereon executable instructions that, as a result of being executed by one or more processors of a computer system, cause the computer system to perform operations comprising:
accessing input data, wherein the input data includes unstructured data;
processing the input data using a statement-extraction machine-learning model to generate a plurality of candidate hypothetical statements and summary data associated with the input data;
constructing one or more filtering prompts for filtering the plurality of candidate hypothetical statements;
processing the one or more filtering prompts and the plurality of candidate hypothetical statements using the statement-extraction machine-learning model to identify one or more hypothetical statements, wherein the one or more hypothetical statements correspond to one or more non-factual assertions associated with the unstructured data; and
transmitting the summary data of the input data and the one or more hypothetical statements, wherein the summary data of the input data and the one or more hypothetical statements are processed using a context-determination machine-learning model to generate contextual data associated with the input data.

18. The non-transitory, computer-readable storage medium of claim 17, wherein the unstructured data includes image data, wherein generating the plurality of candidate hypothetical statements includes applying the statement-extraction machine-learning model to the image data to generate an image-based candidate hypothetical statement, wherein the image-based candidate hypothetical statement includes a description of one or more image objects depicted in the image data.

19. The non-transitory, computer-readable storage medium of claim 17, wherein the unstructured data includes video data, wherein generating the plurality of candidate hypothetical statements includes applying the statement-extraction machine-learning model to the video data to generate a video-based candidate hypothetical statement, and wherein the video-based candidate hypothetical statement includes a description of one or more video objects streamed on the video data.

20. The non-transitory, computer-readable storage medium of claim 17, wherein the unstructured data includes audio data, wherein generating the plurality of candidate hypothetical statements includes applying the statement-extraction machine-learning model to the audio data to generate an audio-based candidate hypothetical statement, and wherein the audio-based candidate hypothetical statement includes a description of one or more objects specified in the audio data.
